(19) United States
(12) Patent Application Publication
(10) Pub. No.: US 2020/0175400 A1
(43) Pub. Date: Jun. 4, 2020

(54) TRIP PURPOSE ESTIMATION APPARATUS

(71) Applicant: AISIN SEIKI KABUSHIKI KAISHA, Kariya-shi (JP)

(72) Inventors: Yuhei MORI, Kariya-shi (JP); Eiji NIWA, Kariya-shi (JP); Hiroshi NOMA, Kariya-shi (JP)

(73) Assignee: AISIN SEIKI KABUSHIKI KAISHA, Kariya-shi (JP)

(21) Appl. No.: 16/693,440

(22) Filed: Nov. 25, 2019

(30) Foreign Application Priority Data
Nov. 29, 2018 (JP) 2018-223874

(51) Int. Cl. G06N 5/04; G07C 5/02

(52) U.S. Cl. CPC G06N 5/04; G07C 5/02

(57) ABSTRACT

A trip purpose estimation apparatus includes a trip information acquisition unit acquiring trip information per trip of a vehicle, the trip information including a departure point, an arrival point, a departure time, and an arrival time of the vehicle, a trip information storage unit storing a history of the trip information acquired by the trip information acquisition unit, a differential calculation unit calculating a time of stay of the vehicle at the arrival point of a target trip based on the history of the trip information stored in the trip information storage unit, the target trip corresponding to the trip in which a trip purpose of a passenger of the vehicle is estimated, and a trip purpose estimation unit estimating the trip purpose of the passenger of the vehicle to the arrival point of the target trip based on the calculated time of stay.

### CROSS REFERENCE TO RELATED APPLICATIONS

This application is based on and claims priority under 35 U.S.C. § 119 to Japanese Patent Application 2018-223874, filed on Nov. 29, 2018, the entire content of which is incorporated herein by reference.

### TECHNICAL FIELD

This disclosure generally relates to a trip purpose estimation apparatus.

### BACKGROUND DISCUSSION

Technologies estimating a purpose of a trip taken by a vehicle (hereinafter referred to as a trip purpose) based on or in response to a target place of the vehicle and distributing an advertisement in accordance with the estimated purpose of the trip to a passenger of the vehicle are disclosed in JP2010-181370A and JP2009-080337A.

However, in a case where the trip purpose of the vehicle is estimated based on the target place of the vehicle, the estimation accuracy of the trip purpose may be decreased. For example, in a case where the target place of the vehicle is a station, the trip purpose is a pick up if the number of the passengers increases, and may be a trip to the station if the vehicle is parked for a long time after arriving at the station.

As such, in a case where the estimation accuracy of the trip purpose of the vehicle decreases, the vehicle cannot distribute an appropriate advertisement, and may distribute an advertisement that does not matches needs of the passenger who then may feel uncomfortable. Accordingly, the estimation accuracy of the trip purpose why the vehicle trips to the target place is required to be enhanced.

A need thus exists for a trip purpose estimation apparatus which is not susceptible to the drawback mentioned above.

### SUMMARY

According to an aspect of this disclosure, a trip purpose estimation apparatus includes a trip information acquisition unit acquiring trip information per trip of a vehicle, the trip information including a departure point, an arrival point, a departure time, and an arrival time of the vehicle, a trip information storage unit storing a history of the trip information acquired by the trip information acquisition unit, a differential calculation unit calculating a time of stay of the vehicle at the arrival point of a target trip based on the history of the trip information stored in the trip information storage unit, the target trip corresponding to the trip in which a trip purpose of a passenger of the vehicle is estimated, and a trip purpose estimation unit estimating the trip purpose of the passenger of the vehicle to the arrival point of the target trip based on the calculated time of stay.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view illustrating an example of a whole structure of a trip purpose estimation system according to an embodiment disclosed here;

FIG. 2 is a block diagram illustrating an example of a hardware configuration of a trip purpose estimation apparatus according the embodiment;

FIG. 3 is a block diagram illustrating an example of a system configuration of a vehicle control system mounted on a vehicle according to the embodiment;

FIG. 4 is a block diagram illustrating an example of functional configurations of the trip purpose estimation apparatus and an Electronic Control Unit;

FIG. 5 is a view illustrating an example of trip information stored in a trip information storage unit of the trip purpose estimation apparatus according to the embodiment;

FIGS. 6A and 6B are diagrams explaining an example of an estimation process of a trip purpose estimated by the trip purpose estimation apparatus according to the embodiment;

FIG. 7 is a flowchart illustrating an example of a flow of a transmission process of the trip information transmitted by the vehicle according to the embodiment; and

FIG. 8 is a flowchart illustrating an example of a flow of a transmission process of advertising information transmitted by the trip purpose estimation apparatus according to the embodiment.

### DETAILED DESCRIPTION

Hereinafter, an exemplified embodiment of the disclosure will be disclosed. The configuration of the embodiment which will be disclosed hereunder, and actions, results, and effects that will be brought by the configuration are merely examples. The disclosure may be achieved with a configuration other than a configuration disclosed in the following embodiment, and may obtain at least one of effects and derivative effects based on the basic configuration.

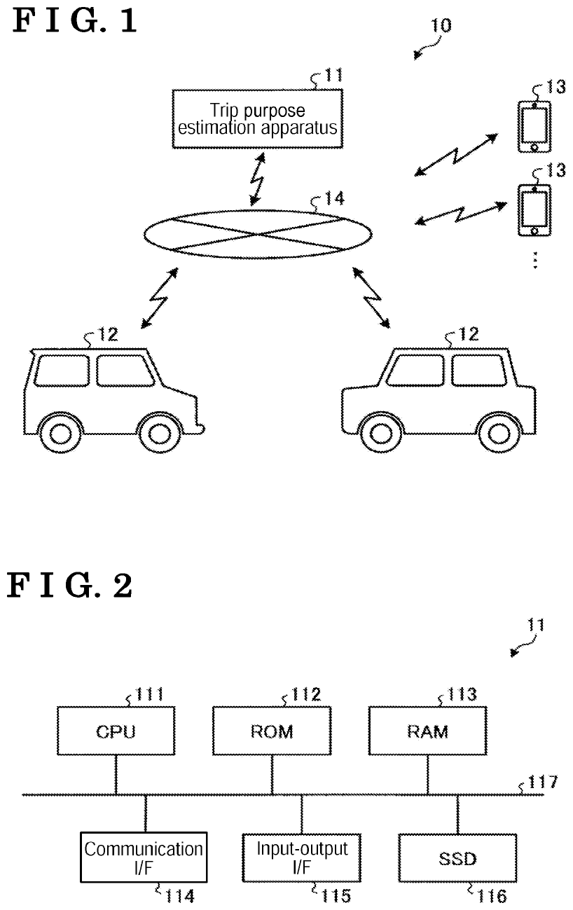

An example of a whole structure of a trip purpose estimation system according to the embodiment will hereunder be explained with reference to FIG. 1.

As illustrated in FIG. 1, a trip purpose estimation system 10 of the embodiment includes a trip purpose estimation apparatus 11, plural vehicles 12, and plural mobile devices 13. The trip purpose estimation apparatus 11, the plural vehicles 12, and the plural mobile devices 13 are connected with one another so that information can be transmitted by for example, wireless communication, via a network 14, for example, internet.

The trip purpose estimation apparatus 11 corresponds to a computer, for example a cloud or a server connected to the network 14. The trip purpose estimation apparatus 11 acquires the trip information of the vehicles 12 within the trip purpose estimation system 10, and estimates trip purposes of the vehicles 12 based on or in response to the acquired trip information. The trip purpose estimation apparatus 11 performs, based on the estimated trip purposes, marketing operation including the distribution of the advertising information and the optimal design of Mobility as a Service or MaaS relative to the vehicles 12 and the mobile devices 13.

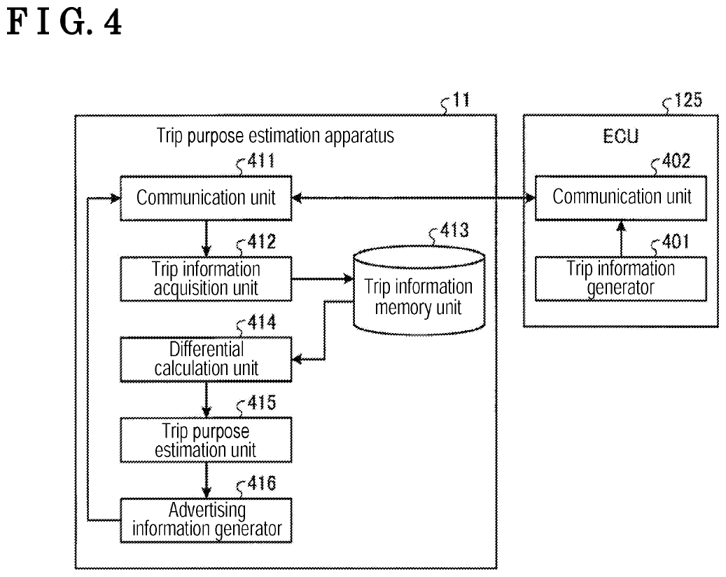

The vehicles 12 acquire the trip information, and transmit the acquired trip information to the trip purpose estimation apparatus 11 via the network 14. The vehicles 12 receive the advertising information from the trip purpose estimation apparatus 11 via the network 14. The vehicle 12 offers a passenger the advertising information by outputting the received advertising information to a display unit 126 (see FIG. 3) or an audio output unit 127 (see FIG. 3) included by the vehicle 12.

The mobile device 13 corresponds to a mobile device, for example, a smartphone, a tablet, and a cellphone possessed by the passenger of the vehicle 12. The mobile device 13 receives the advertising information from the trip purpose estimation apparatus 11, and offers the advertising information to the passenger by outputting the received advertising information to a display unit and an audio output unit included by the mobile device 13.

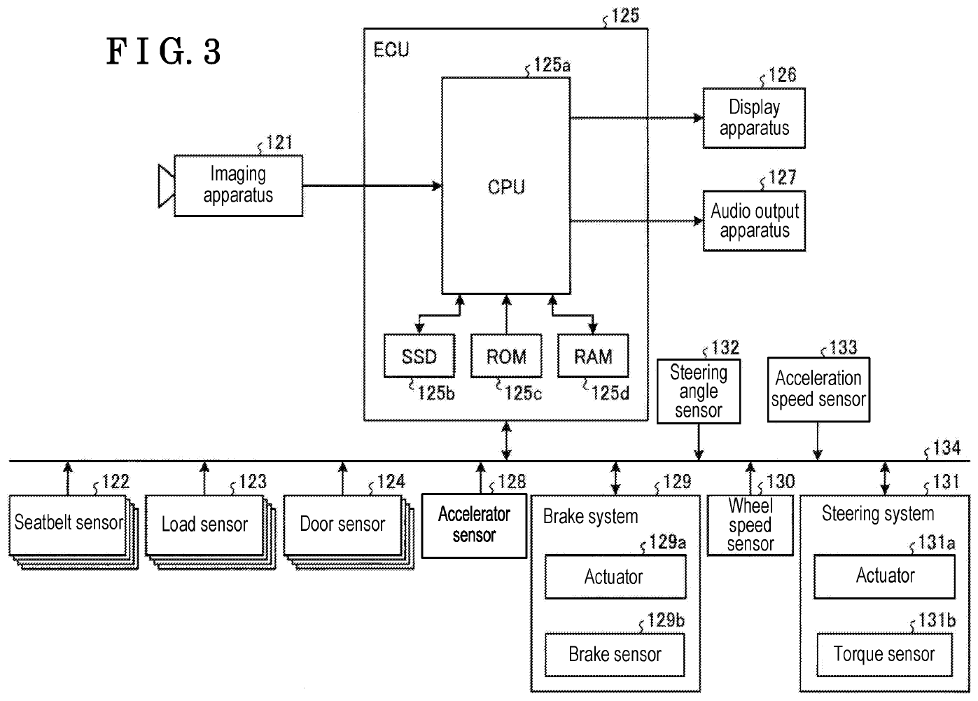

Next, an example of a hardware configuration of the trip purpose estimation apparatus 11 according to the embodiment will hereunder be explained with reference to FIG. 2.

As illustrated in FIG. 2, the trip purpose estimation apparatus 11 of the embodiment includes a computer resource which is similar to a general information processor, for example, a personal computer or a PC.

As illustrated in FIG. 2, the trip purpose estimation apparatus 11 is provided with a Central Processing Unit 111 of a CPU 111, a Read Only Memory 112 or a ROM 112, a Random Access Memory 113 or a RAM 113, a communication interface (I/F) 114, an input-output interface (I/F) 115, and a Solid State Drive 116 or a SSD 116. The hardware devices are connected to one another via a data bus 117.

The CPU 111 corresponds to a hardware processor integrally controlling the trip purpose estimation apparatus 11. The CPU 111 reads out control programs (computer programs) stored in, for example, the ROM 112, and operates functions in accordance with instructions determined by the control programs.

The ROM 112 corresponds to a non-volatile main memory device storing, for example, parameters required to operate the above-mentioned control programs.

The RAM 113 corresponds to a volatile main memory device offering a working space of the CPU 111.

The communication interface 114 corresponds to an interface operating the communication between the trip purpose estimation apparatus 11 and an external device. For example, the communication interface 114 sends and receives signals of wireless communications between the trip purpose estimation apparatus 11 and the vehicle 12 or the mobile device 13.

The input-output interface 115 corresponds to an interface connecting the trip purpose estimation apparatus 11 and the external device. The external device corresponds to an input-output device used by an operator of the trip purpose estimation apparatus 11.

The SSD 116 corresponds to a rewritable, non-volatile auxiliary storage device. Alternatively, the trip purpose estimation apparatus 11 of the embodiment may include a Hard Disk Drive or a HDD instead of or in addition to the SSD 116 as the auxiliary storage device.

Next, a system configuration of a vehicle control system mounted on the vehicle 12 according to the embodiment will hereunder be explained.

As illustrated in FIG. 3, the vehicle control system includes an imaging unit 121, a seat belt sensor 122, a load sensor 123, a door sensor 124, an Electronic Control Unit 125 or an ECU 125, a display unit 126, the audio output unit 127, an accelerator sensor 128, a brake system 129, a wheel speed sensor 130, a steering system 131, a steering angle sensor 132, and an acceleration speed sensor 133.

As illustrated in FIG. 3, in the vehicle control system, for example, the seat belt sensor 122, the load sensor 123, the door sensor 124, the ECU 125, the accelerator sensor 128, the brake system 129, the wheel speed sensor 130, the steering system 131, the steering angle sensor 132, and the acceleration speed sensor 133 are electrically connected with one another via an in-vehicle network 134.

The in-vehicle network 134 is configured as, for example, a Controller Area Network or a CAN. The ECU 125 receives for example, detection results of sensors, for example, the seat belt sensor 122, the load sensor 123, the door sensor 124, the accelerator sensor 128, a brake sensor 129b, the wheel speed sensor 130, a torque sensor 131b, the steering angle sensor 132, and the acceleration speed sensor 133 via the in-vehicle network 134.

The imaging unit 121 corresponds to a digital camera including an image sensor or an imaging element, for example, a Charge Coupled Device or a CCD, or a CMOS Image Sensor or a CIS. The imaging unit 121 is provided so as to image a vehicle compartment of the vehicle 12. The imaging unit 121 outputs image data (captured image) acquired by imaging the vehicle compartment of the vehicle 121 to the ECU 125.

The display unit 126 corresponds to a Liquid Crystal Display or a LCD, or an Organic Electroluminescent Display or an GELD. The audio output unit 127 corresponds to, for example, a loudspeaker. The display unit 126 is covered by a translucent operation input unit, for example, a touch panel. The passenger, for example a driver, may see images displayed on a display screen of the display unit 126 via the operation input unit. The passenger can also operate the operation input at a position corresponding to the images displayed on the display screen of the display unit 126 by touching, pressing, and moving the operation input unit using his/her hand or finger.

The display unit 126, the audio output unit 127, the operation input unit or the like are provided at a monitor unit disposed at, for example, a center portion of a dashboard of the vehicle 12 in the vehicle width direction which is the right-left direction. The monitor unit may include an operation input unit, for example, a switch, a dial, a joystick, or a press button. The monitor unit may also be used with a navigation system or an audio system.

The steering system 131 corresponds to, for example, an electric power steering system or a Steer-by-Wire system or a SbW system. The steering system 131 includes an actuator 131a and the torque sensor 131b. The steering system 131 is electrically controlled by, for example, the ECU 125. The steering system 131 steers wheels of the vehicle 12 by applying the torque to supplement the steering force relative to a steering unit, for example, a steering wheel of the vehicle 12 by operating the actuator 131a. The torque sensor 131b detects the torque applied to the steering unit by the driver and sends the detection result to the ECU 125.

The brake system 129 includes an Anti-lock Brake System or an ABS controlling the lock of the brake of the vehicle 12, a sideslipping prevention unit or a skidding prevention unit (or Electronic Stability Control or ESC) preventing the sideslipping or skidding of the vehicle 12 when the vehicle 12 turns a corner, an electric brake system assisting the brake function by reinforcing braking force, and a Brake-by-Wire system or a BbW system. The brake system 129 includes an actuator 129a and the brake sensor 129b. The brake system 129 is electrically controlled by, for example, the ECU 125, and applies the brake force to the wheels of the vehicle 12 via the actuator 129a. The brake system 129 detects, for example, signs of the lock of the brake, the slipping of the wheels, and sideslipping by a difference of rotation of a right wheel and a left wheel, and performs the control of the inhibition of the lock of the brake, the slipping of the wheels, and the sideslipping. The brake sensor 129b corresponds to a displacement sensor detecting the position of the brake pedal as a moving part of a brake operation unit of the vehicle 12, and sends the detection result of the position of the brake pedal to the ECU 125.

The acceleration speed sensor 133 detects acceleration speed applied to the vehicle 12, and outputs the detection result to the ECU 125 via the in-vehicle network 134. In the embodiment, the acceleration speed sensor 133 detects the acceleration speed of at least one direction of the front-rear direction, the right-left direction, and the upper-lower direction of the vehicle 12.

The steering angle sensor 132 corresponds to a sensor detecting the steering amount of the steering unit. In the embodiment, the steering angle sensor 132 is configured by, for example, a hall element. The steering angle sensor 132 detects rotation angle of a rotation part of the steering unit as a steering amount of the steering unit, and outputs the detection result to the ECU 125 via the in-vehicle network 134.

The accelerator sensor 128 corresponds to a displacement sensor detecting the position of an accelerator pedal as a moving part of a speed operation unit, and outputs the detection result to the ECU 125 via the in-vehicle network 134. The wheel speed sensor 130 corresponds to a sensor including, for example, a hall element. The wheel speed sensor 130 detects the rotation amount of the wheels and the rotation speed of the wheels per unit time, and outputs the detection result to the ECU 125 via the in-vehicle network 134.

The seatbelt sensor 122 is provided at each of plural seats of the vehicle 12. The seatbelt sensor 122 detects on-off states of the seatbelts of the seats included by the vehicle 12 and outputs the detection result to the ECU 125 via the in-vehicle network 134.

The load sensor 123 is provided at each of the seats of the vehicle 12. The load sensor 123 detects load applied to the seat and outputs the detection result to the ECU 125 via the in-vehicle network 134.

The door sensor 124 is provided at each of the doors of the vehicle 12. The door sensor 124 detects whether the door is in an open state or in a closed state, and outputs the detection result to the ECU 125 via the in-vehicle network 134.

The ECU 125 includes, for example, a CPU 125a, a SSD 125b, a ROM 125c, and a RAM 125d. The CPU 125a operates the entire control of the vehicle 12. The CPU 125a reads out programs installed and stored in the non-volatile storage unit, for example, the ROM 125c, and performs processing operation in accordance with the programs. The RAM 125d temporarily stores data employed in the processing operation in CPU 125a. The SSD 125b corresponds to a rewritable, non-volatile storage unit and stores data even in a case where the power supply of the ECU 125 is in an off state.

The CPU 125a, the ROM 125c, the RAM 125d and the like may be accumulated within the same package. Alternatively, in the ECU 125, other logical operation processors or logic circuits, for example, a Digital Signal Processor or a DSP may be employed instead of the CPU 125a. The HDD may be provided instead of the SSD 125b, and the SSD 125b and the HDD may be separately provided from the ECU 125.

Meanwhile, the technology estimating the trip purpose of the vehicle 12 based on the target place or a single route of the vehicle 12, and distributing the advertising information to the passenger of the vehicle 12 in accordance with the estimated trip purpose has been developed.

However, in a case where the trip purpose of the vehicle 12 is estimated based on or in response to the target place or the single route of the vehicle 12, the estimation accuracy of the trip purpose may be decreased. In a case where the estimation accuracy of the trip purpose of the vehicle 12 is decreased, the vehicle 12 cannot distribute appropriate advertisements to the passenger of the vehicle 12. Since the vehicle 12 distributes an advertisement that does not matches needs of the passenger, the passenger may feel uncomfortable.

Here, in the embodiment, the trip purpose estimation apparatus 11 and the ECU 125 include functions which will be explained as follows. Estimation of the trip purpose of the vehicle 12 to the target place based on plural routes of the vehicle 12 achieves the enhancement of the estimation accuracy of the trip purpose of the vehicle 12.

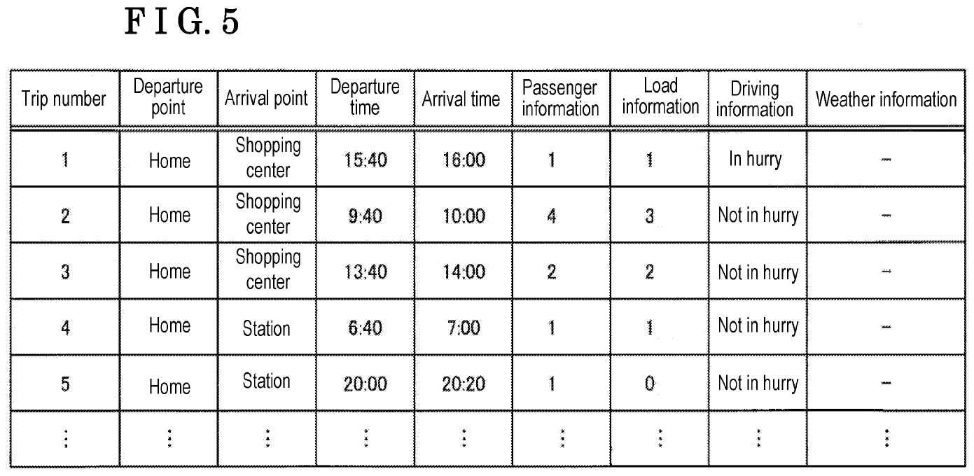

Next, examples of the functional configurations of the trip purpose estimation apparatus 11 and the ECU 125 of the embodiment will hereunder be explained. The functions of the trip purpose estimation apparatus 11 and the ECU 125 shown in FIG. 4 are achieved by the combination of software and hardware.

That is, as illustrated in the example in FIG. 4, the function of the trip purpose estimation apparatus 11 is achieved as a result in which the CPU 111 reads out and operates the program stored in, for example, the ROM 112. The function of the ECU 125 is achieved as a result in which the CPU 125a reads out and operates the program stored in, for example, the ROM 125c. Alternatively, a part or all of the functions of the trip purpose estimation apparatus 11 and the ECU 125 shown in FIG. 4 may be achieved by dedicated or exclusive hardware (circuit).

As illustrated in FIG. 4, the ECU 125 includes a trip information generator 401 and a communication unit 402. The trip information generator 401 generates the trip information of the vehicle 12 per trip. Here, the trip corresponds to the trip of the vehicle 12 to a target place.

The trip information corresponds to the information regarding the trip of the vehicle 12, and shall at least include a departure point, an arrival point, a departure time, and an arrival time of the vehicle 12 in the trip. In the embodiment, the trip information at least includes passenger information, load information, driving information and weather information in addition to the departure point, the arrival point, the departure time, and the arrival time.

Here, the passenger information corresponds to information relative to the passenger of the vehicle 12, and includes at least one of the number, the sex, and the age of the passengers of the vehicle 12. The load information corresponds to information relative to load loaded on the vehicle 12, and includes at least one of the number and the weight of the load loaded on the vehicle 12. The driving information corresponds to information relative to the driving tendency of the driver of the vehicle 12, and shows whether the driver of the vehicle 12 is in hurry or the driver drives normally (in other words, the driver is not in hurry). The weather information corresponds to information showing weather condition of the arrival point.

In the embodiment, the trip information generator 401 generates the departure point and the arrival point of the trip by employing the current position of the vehicle 12 detected based on, for example, radio waves received by a Global Positioning System receiver, or a GPS receiver, or employing the current position of the vehicle 12 estimated by a positioning estimation method, for example, odometry or dead reckoning. In the embodiment, the trip information generator 401 generates the departure time and the arrival time of the vehicle 12 in the trip by employing the time calculated by a calculation unit of, for example, a real-time clock or a RTC included by the ECU 125.

In the embodiment, the trip information generator 401 generates passenger information based on, for example, captured images obtained by the imaging unit 121 which images the vehicle compartment of the vehicle 12, the on-off states of the seatbelt detected by the seatbelt sensor 122, the load applied to each of the seats detected by the load sensor 123, and an opening state and a closed state of each of the doors detected by the door sensor 124.

Further in the embodiment, the trip information generator 401 generates load information based on, for example, captured images obtained by the imaging unit 121 which images the vehicle compartment of the vehicle 121, the load applied to each of the seats detected by the load sensor 123, and the opening state and the closed state of each of the doors detected by the door sensor 124.

Furthermore, in the embodiment, the trip information generator 401 determines whether the driver of the vehicle 12 is in hurry or not based on, for example, the detection result of the position of the accelerator pedal by the accelerator sensor 128, the detection result of the position of the brake pedal by the brake sensor 129b, the detection result of the rotation speed of the wheel by the wheel speed sensor 130, the detection result of the amount of the steering by the wheel angle sensor 132, and the detection result of the accelerator speed by the accelerator speed sensor 133. The trip information generator 401 generates driving information based on the determination results.

In the embodiment, the trip information generator 401 generates weather information (for example, sunny, cloud, rain, snow) based on weather information or the like distributed by, for example, cloud.

The communication unit 402 may communicate with external devices, for example, the trip purpose estimation apparatus 11 or the mobile device 13 via the network 14. In the embodiment, the communication unit 402 sends the trip information generated by the trip information generator 401 to the trip purpose estimation apparatus 11. The communication unit 402 receives the advertising information from the trip purpose estimation apparatus 11 via the network 14. The communication unit 402 displays the advertising information received by the trip purpose estimation apparatus 11 on the display unit 126, or outputs the advertising information received by the trip purpose estimation apparatus 11 with the audio output unit 127.

Next, the functional configuration of the trip purpose estimation apparatus 11 will hereunder be explained with reference to the FIG. 4. As shown in FIG. 4, the trip purpose estimation apparatus 11 includes a communication unit 411, a trip information acquisition unit 412, a trip information storage unit 413, a differential calculation unit 414, a trip purpose estimation unit 415, and an advertising information generator 416.

The trip information storage unit 413 corresponds to a storage unit, for example, the SSD 116, and stores a history of trip information acquired by the trip information acquisition unit 412.

The communication unit 411 is communicable with the external device, for example, the vehicles 12 or the mobile devices 13 via the network 14. In the embodiment, the communication unit 411 receives the trip information from the vehicles 12 via the network 14. The communication unit 411 transmits the advertising information generated by the advertising information generator 416 to the vehicles 12 or the mobile devices 13 via the network 14.

The trip information acquisition unit 412 acquires the trip information received from the communication unit 411, and stores the acquired trip information to the trip information storage unit 413. In the embodiment, the trip information acquisition unit 412 acquires the trip information received from the vehicle 12 via the communication unit 411, which is not limited as such. For example, the trip information acquisition unit 412 may generate trip information of the vehicle 12 per trip like the trip information generator 401, and store the generated trip information to the trip information storage unit 413.

The trip information storage unit 413 stores the history of the trip information acquired by the trip information acquisition unit 412.

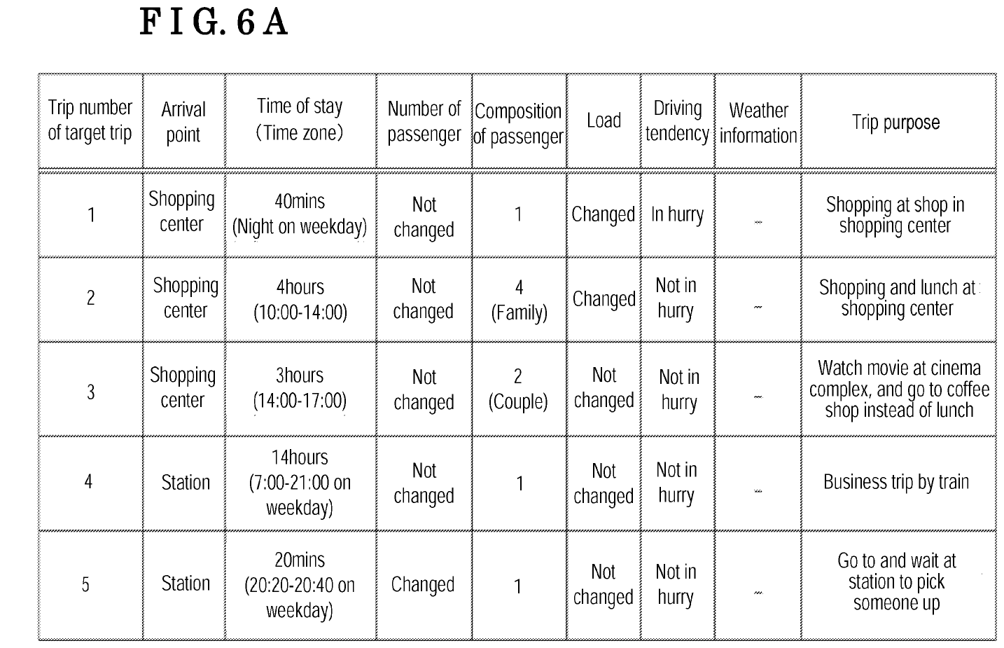

As illustrated in FIG. 5, in the embodiment, the trip information storage unit 413 stores, per the vehicle 12, the departure point, the arrival point, the departure time, the arrival time, the passenger information, the load information, the driving information, and the weather information included by the trip information of the trip by connecting to or corresponding to trip numbers which may distinguish trips of the vehicles 12.

Back to FIG. 4, the differential calculation unit 414 calculates the time of stay of the vehicle 12 at the arrival point of the target trip based on the history of the trip information stored in the trip information storage unit 413. Here, the target trip corresponds to a trip in which the trip purpose of the passenger of the vehicle 12 is estimated. In the embodiment, the differential calculation unit 414 calculates the time of stay based on the trip information of the target trip and the trip information of a following trip. Here, the following trip corresponds to a next trip after the target trip. Specifically, the differential calculation unit 414 calculates the difference of the arrival time included by the trip information of the target trip and the departure time included by the trip information of the following trip as a time of stay at the arrival point of the target trip.

However, in a case where the target trip corresponds to the latest trip or the newest trip, the trip information of the following trip is not yet acquired. Thus, the differential calculation unit 414 estimates the trip information of the following trip based on the history of the trip information stored in the trip information storage unit 413. The differential calculation unit 414 calculates the time of stay at the arrival time of the vehicle in the target trip based on the trip information of the target trip and the trip information of the estimated following trip. Accordingly, even in a case where the target trip is the latest trip, the time of stay at the arrival point of the target trip may be calculated.

In the embodiment, the differential calculation unit 414 estimates the trip information of the following trip based on the trip information of the following trip of a trip similar to the target trip (hereinafter referred to as a similar trip) from the history of the trip information stored in the trip information storage unit 413. Here, the similar trip corresponds to a trip in which the trip information which is similar to the trip information of the target trip is acquired. In the embodiment, the similar trip corresponds to a trip in which at least one of the departure point, the arrival point, the departure time, the arrival time, the passenger information, the load information, the driving information and the weather information included by the trip information of the target trip is matched or coincided.

The differential calculation unit 414 calculates time zone, in which the passenger of the vehicle 12 has stayed at the arrival point of the target trip (hereinafter referred to as a time zone of stay), based on the history of the trip information stored in the trip information storage unit 413. For example, the differential calculation unit 414 calculates the time zone, from the arrival time included by the trip information of the target trip to the departure time included by the trip information of the following trip, as a time zone of stay in which the passenger of the vehicle 12 has stayed at the arrival point of the target trip.

The differential calculation unit 414 estimates the composition of the passengers (for example, family, couple, or a family including a baby) of the vehicle 12 based on the history of the trip information stored in the trip information storage unit 413. The differential calculation unit 414 calculates the change of the number of the passengers of the vehicle 12 at the arrival point of the target trip based on the history of the trip information stored in the trip information storage unit 413. In the embodiment, the differential calculation unit 414 calculates the difference between the number of the passengers included by the trip information of the target trip and the number of the passengers included by the trip information of the following trip as the change of the number of the passengers of the vehicle 12.

The differential calculation unit 414 calculates increase and decrease of loads at the arrival point of the target trip based on the history of the trip information stored in the trip information storage unit 413. In the embodiment, the differential calculation unit 414 calculates the increase and decrease of the loads based on the difference between the number of the loads shown by the load information included by the trip information of the target trip and the number of the loads shown by the load information included by the trip information of the following trip. Alternatively, the differential calculation unit 414 calculates the increase and decrease of the loads based on the weight of the load shown by the load information included by the trip information of the target trip and the weight of the load shown by the load information included by the trip information of the following trip.

The trip purpose estimation unit 415 estimates the trip purpose of the passenger of the vehicle 12 to the arrival point of the target trip based on the time of stay calculated by the differential calculation unit 414, the time of stay which is an example of conditions employed for the estimation of the trip purpose (hereinafter referred to as an estimation condition). Accordingly, the trip purpose may be estimated based on the information relating to the action of the passenger of the vehicle 12 at the arrival point of the target trip so that the estimation accuracy of the trip purpose at the arrival point of the passenger of the vehicle 12 may be enhanced.

For example, the trip purpose estimation unit 415 connects the trip purpose to a rule of the estimation condition for estimating the trip purpose, and previously stores them to a storage device, for example, the SSD 116. Then, the trip purpose estimation unit 415 estimates the trip purpose stored by being connected to the rule satisfied by the estimation condition (for example, time of stay) as a trip purpose of the passenger of the vehicle 12 to the arrival point of the target trip. Alternatively, in a case where the estimation result of the trip purpose in which the rule is employed is accumulated, the trip purpose estimation unit 415 may learn the estimation result by machine learning, and may estimate the trip purpose stored by connecting the learning result to the estimation condition (for example, the time of stay) as a trip purpose of the target trip.

In the embodiment, the trip purpose estimation unit 415 estimates the trip purpose based on the arrival point included by the trip information of the target trip, the arrival point which is an example of the estimation condition, in addition to the time of stay calculated by the differential calculation unit 414. Accordingly, the trip purpose may be estimated based on further detailed information which relates to the action of the passenger of the vehicle 12 at the arrival point of the target trip so that the estimation accuracy of the trip purpose at the arrival point of the passenger of the vehicle 12 may be enhanced.

In the embodiment, the trip purpose estimation unit 415 estimates the trip purpose based on the time zone of stay calculated by the differential calculation unit 414, the time zone of stay which is an example of the estimation condition, in addition to the time of stay calculated by the differential calculation unit 414. Accordingly, the trip purpose may be estimated based on the further detailed information which relates to the action of the passenger of the vehicle 12 at the arrival point of the target trip so that the estimation accuracy of the trip purpose at the arrival point of the passenger of the vehicle 12 may be enhanced.

In the embodiment, alternatively, the trip purpose estimation unit 415 may estimate the trip purpose based on the composition of the passengers estimated by the differential calculation unit 414, the composition of the passengers, which is an example of the estimation condition, in addition to the time of stay. Accordingly, the trip purpose may be estimated based on the information which relates to the further detailed action of the passenger of the vehicle 12 at the arrival point of the target trip so that the estimation accuracy of the trip purpose at the arrival point of the passenger of the vehicle 12 may be enhanced. In the embodiment, alternatively, the trip purpose estimation unit 415 may estimate the trip purpose based on the change of number of the passengers calculated by the differential calculation unit 414, the change of number of the passengers, which is an example of the estimation condition, in addition to the time of stay and the composition of the passengers. Accordingly, the trip purpose may be estimated based on the information which relates to further detailed information of the passenger of the vehicle 12 at the arrival point of the target trip so that the estimation accuracy of the trip purpose at the arrival point of the passenger of the vehicle 12 may be enhanced.

In the embodiment, alternatively, the trip purpose estimation unit 415 may estimate the trip purpose at the arrival point of the passenger of the vehicle 12 based on the increase and decrease of the loads calculated by the differential calculation unit 414, the increase and decrease of the loads, which is an example of the estimation condition, in addition to the time of stay. Accordingly, the trip purpose may be estimated based on the information which relates to further detailed information of the passenger of the vehicle 12 at the arrival point of the target trip so that the estimation accuracy of the trip purpose at the arrival point of the passenger of the vehicle 12 may be enhanced.

In the embodiment, alternatively, the trip purpose estimation unit 415 may estimate the trip purpose at the arrival point of the passenger of the vehicle 12 based on the driving information included by the trip information of the target trip, the driving information which is an example of the estimation condition, in addition to the time of stay. Accordingly, the trip purpose may be estimated based on the information based on further detailed information which relates to the trip of the vehicle 12 to the arrival point of the target trip so that the estimation accuracy of the trip purpose at the arrival point of the passenger of the vehicle 12 may be enhanced.

In the embodiment, alternatively, the trip purpose estimation unit 415 may estimate the trip purpose at the arrival point of the passenger of the vehicle 12 based on the weather information included by the trip information of the target trip, the weather information which is an example of the estimation condition, in addition to the time of stay. Accordingly, the trip purpose may be estimated based on the further detailed information which relates to the trip of the vehicle 12 to the arrival point of the target trip so that the estimation accuracy of the trip purpose at the arrival point of the passenger of the vehicle 12 may be enhanced.

That is, in the embodiment, the trip purpose estimation unit 415 may estimate the trip purpose at the arrival point of the passenger of the vehicle 12 of the target trip based on at least one of the arrival point, the time zone of stay, the change of number of the passengers, the composition of the passengers, the increase and decrease of the loads, the driving information, and the weather information as an example of the estimation condition, in addition to the time of stay.

In the embodiment, alternatively, the trip purpose estimation unit 415 may estimate the trip purpose at the arrival point of the passenger of the vehicle 12 of the target trip based on the estimation result of the trip purpose of other trip other than the target trip in addition to the time of stay. For example, the trip purpose estimation unit 415 estimates the trip purpose at the arrival point of the passenger of the vehicle 12 of the target trip based on the estimation result of the trip purpose of a last trip (an immediately before trip) of the target trip, or the estimation result of the trip purpose of the similar trip. Accordingly, the trip purpose of the target trip may be estimated in consideration of the estimated result of the trip purpose of other trips so that the estimation accuracy of the trip purpose at the arrival point of the passenger of the vehicle 12 may be enhanced. Alternatively, the trip purpose estimation unit 415 may estimate the trip purpose of the trip purpose of the target trip again based on the estimation result of the trip purpose of other trips after once estimating the trip purpose of the target trip, and may update the trip purpose of the target trip by employing the re-estimated trip purpose.

In the embodiment, the trip purpose estimation unit 415 acquires purchasing information of the passenger of the vehicle 12 at the arrival point by a point-of-sales system, or a POS system. The trip purpose estimation unit 415 may estimate the trip purpose at the arrival point of the passenger of the vehicle 12 of the target trip based on the acquired purchasing information in addition to the time of stay.

The advertising information generator 416 generates the advertising information offered to the passenger of the vehicle 12 based on the trip purpose estimated by the trip purpose estimation unit 415. The advertising information generator 416 controls the transmission unit 411 to transmit the generated advertising information to the vehicles 12 and the mobile devices 13.

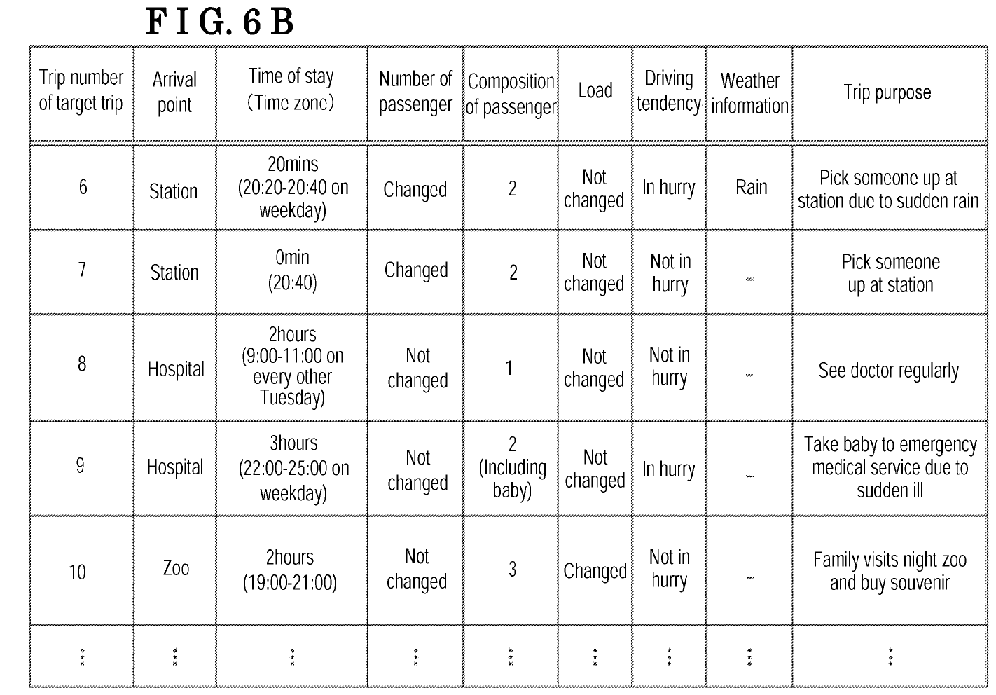

Next, a concrete example of an estimation process of the trip purpose operated by the trip purpose estimation apparatus 11 of the embodiment will hereunder be explained with reference to FIGS. 6A and 6B.

Here, the trip purpose estimation unit 415 estimates the trip purpose at the arrival point of the passenger of the vehicle 12 of the target trip based on, as an example of the estimation condition, the arrival point, the time zone of stay, the change of number of the passengers, the composition of the passengers, the increase and decrease of the loads, the driving information, the weather information, and the trip purpose of other trips, in addition to the time of stay.

As shown in FIG. 6A, the trip purpose estimation unit 415 estimates the trip purpose of the target trip of the trip number 1. As shown in FIG. 6A, the target trip number 1 includes an arrival point which is a shopping center, a time of stay which is 40 minutes, a time zone of stay which is weekday night, the change of the number of the passengers, which is not changed, and the number of the passengers is one, an increase and decrease of the loads, which is an increase thereof, and the tendency of driving which is in hurry. In this case, the passenger of the vehicle 12 tends to go shopping at the shopping center. Accordingly, as shown in FIG. 6A, the trip purpose estimation unit 415 estimates the shopping at a specific shop in the shopping center as the trip purpose of the target trip as the trip purpose of the target trip number 1.

The trip purpose estimation unit 415 estimates the trip purpose of the target trip of the trip number 2. As shown in FIG. 6A, the target trip number 2 includes an arrival point which is a shopping center, a time of stay which is 4 hours, a time zone of stay which is day time (for example, from 10:00 to 14:00), the change of the number of the passengers, which is not changed, and the number of the passengers is four, the composition of the passengers, which is family, an increase and decrease of the loads, which is an increase thereof, and the tendency of driving which is not in hurry. The target trip number 2 is similar to the target trip number 1 in terms of the arrival point which is a shopping center as shown in FIG. 6A. However, the trip purpose of the target trip number 2 seems different in consideration of the longer time of stay in the shopping center than that of the target trip number 1. Thus, as shown in FIG. 6A, the trip purpose estimation unit 415 estimates that the trip purpose of the target trip number 2 as a shopping and lunch at the shopping center.

The trip purpose estimation unit 415 estimates the trip purpose of the target trip of the trip number 3. As shown in FIG. 6A, the target trip number 3 includes an arrival point which is a shopping center, a time of stay which is 3 hours, a time zone of stay which is late afternoon (for example, from 14:00 to 17:00), the change of the number of the passengers, which is not changed, and the number of the passengers is two, the composition of the passengers, which is couple, an increase and decrease of the loads, which is not changed, and the tendency of driving which is not in hurry. The target trip number 3 is similar to the target trip number 2 in terms of the arrival point which is a shopping center, and in terms of rather long time of stay as shown in FIG. 6A. However, the trip purpose of the target trip number 3 seems different from the trip purpose of the target trip number 2 in consideration of the time zone of stay which is late afternoon. Thus, as shown in FIG. 6A, the trip purpose estimation unit 415 estimates that the trip purpose of the target trip number 3 as watching movie at the cinema complex of the shopping center and going to a coffee shop instead of lunch.

The trip purpose estimation unit 415 estimates the trip purpose of the target trip of the trip number 4. As shown in FIG. 6A, the target trip number 4 includes an arrival point which is a station, a time of stay which is 14 hours, a time zone of stay which is from morning to night of weekday (for example, from 7:00 to 21:00), the change of the number of the passengers, which is not changed, and the number of the passengers is one, an increase and decrease of the loads, which is not changed, and the tendency of driving which is not in hurry. In this case, the passenger of the vehicle 12 is likely to park the vehicle 12 at a station and take a train to go business trip. Accordingly, as shown in FIG. 6A, the trip purpose estimation unit 415 estimates the trip purpose of the target trip number 4 as taking the train from the station to go business trip.

The trip purpose estimation unit 415 estimates the trip purpose of the target trip of the trip number 5. As shown in FIG. 6A, the target trip number 5 includes an arrival point which is a station, a time of stay which is 20 minutes, a time zone of stay which is weekday night (for example, from 20:20 to 20:40), the change of the number of the passengers, which is changed from one to two, the increase and decrease of the loads, which is not changed, and the tendency of driving which is not in hurry. The target trip number 5 is similar to the target trip number 4 in terms of the arrival point which is a station as shown in FIG. 6A. However, the trip purpose of the target trip number 5 seems different from the trip purpose of the target trip number 4 in consideration of the shorter time of stay than the target trip number 4, and the time zone of stay which is night only. Thus, as shown in FIG. 6A, the trip purpose estimation unit 415 estimates that the trip purpose of the target trip number 5 as going to and waiting at the station to pick someone up.

The trip purpose estimation unit 415 estimates the trip purpose of the target trip of the trip number 6. As shown in FIG. 6B, the target trip number 6 includes an arrival point which is a station, a time of stay which is 20 minutes, a time zone of stay which is night (for example, from 20:20 to 20:40), the change of the number of the passengers, which is changed from one to two, the increase and decrease of the loads which, is not changed, the tendency of driving which is in hurry, and the weather information which is rain. The target trip number 6 is similar to the target trip number 5 in terms of the arrival point which is a station as shown in FIG. 6B. The target trip number 6 is also similar to the target trip number 5 in terms of the short time of stay, and the time zone of stay which is night only. Thus, as shown in FIG. 6B, the trip purpose estimation unit 415 estimates that the trip purpose of the target trip number 6 as going to the station to pick someone up due to sudden rain.

The trip purpose estimation unit 415 estimates the trip purpose of the target trip of the trip number 7 shown in FIG. 6B. As shown in FIG. 6B, the target trip number 7 includes an arrival point which is a station, a time of stay which is 0 or zero minute, a time zone of stay which is night (for example, at 20:40), the change of the number of the passengers, which is changed from one to two, the increase and decrease of the loads, which is not changed, and the tendency of driving which is not in hurry. The target trip number 7 is similar to the target trip numbers 5 and 6 in terms of the arrival point which is a station as shown in FIG. 6B. The target trip number 7 is also similar to the target trip numbers 5 and 6 in terms of the short time of stay, and the time zone of stay which is night only. Thus, as shown in FIG. 6B, the trip purpose estimation unit 415 estimates that the trip purpose of the target trip number 7 as going to the station to pick up someone who waits at the station.

The trip purpose estimation unit 415 estimates the trip purpose of the target trip of the trip number 8. As shown in FIG. 6B, the target trip number 8 includes an arrival point which is a hospital, a time of stay which is 2 hours, a time zone of stay which is every other Tuesday morning (for example, from 9:00 to 11:00), the change of the number of the passengers, which is not changed, and the number of the passengers is one, an increase and decrease of the loads, which is not changed, and the tendency of driving which is not in hurry. In this case, the passenger of the vehicle 12 tends to go to a hospital to see a doctor regularly. Accordingly, as shown in FIG. 6B, the trip purpose estimation unit 415 estimates the trip purpose of the target trip number 8 as going to the hospital to see the doctor regularly.

The trip purpose estimation unit 415 estimates the trip purpose of the target trip of the trip number 9. As shown in FIG. 6B, the target trip number 9 includes an arrival point which is a hospital, a time of stay which is 3 hours, a time zone of stay which is weekday night (for example, from 22:00 to 25:00), the change of the number of the passengers, which is not changed, and the number of the passengers is two, the composition of the passengers including a baby, an increase and decrease of the loads, which is not changed, and the tendency of driving which is in hurry. The target trip number 9 is similar to the target trip number 8 in terms of the arrival point which is a hospital. However, the trip purpose of the target trip number 9 seems different from the trip purpose of the target trip number 8 in consideration of the different time of stay, and the composition of the passengers including a baby. Thus, as shown in FIG. 6B, the trip purpose estimation unit 415 estimates that the trip purpose of the target trip number 9 as going to an emergency medical service at night due to sudden ill of the baby.

The trip purpose estimation unit 415 estimates the trip purpose of the target trip of the trip number 10. As shown in FIG. 6B, the target trip number 10 includes an arrival point which is a zoo, a time of stay which is 2 hours, a time zone of stay which is night (for example, from 19:00 to 21:00), the change of the number of the passengers, which is not changed and the number of the passengers is three, an increase and decrease of the loads, which is increased, and the tendency of driving which is not in hurry. In this case, a family is likely to visit a zoo for a night event and buy something. Accordingly, as shown in FIG. 6B, the trip purpose estimation unit 415 estimates the trip purpose of the target trip number 10 as visiting of the zoo with the family for the night event and buy souvenirs.

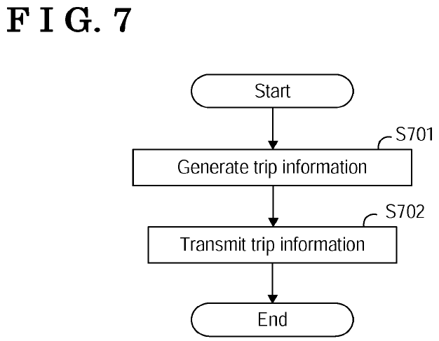

Next, an example of a flow of the transmission process of the trip information by the vehicle 12 of the embodiment will hereunder be explained with reference to FIG. 7.

The trip information generator 401 generates the trip information of the vehicle 12 every time one trip of the vehicle 12 is finished (Step S701).

Next, the communication unit 402 transmits the trip information generated by the trip information generator 401 to the trip purpose estimation apparatus 11 via the network 14 (Step S702).

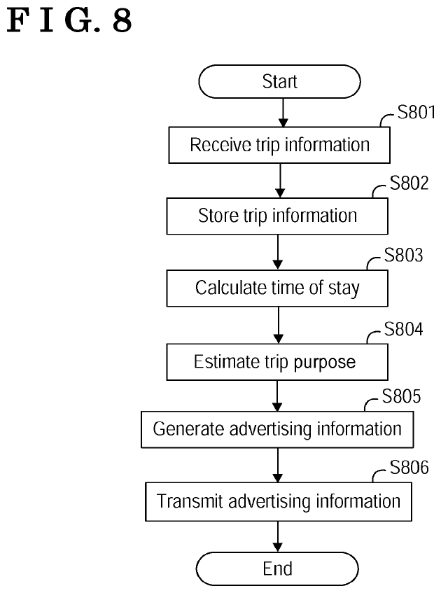

Next, an example of a flow of the transmission process of the advertising information by the trip purpose estimation apparatus 11 of the embodiment will hereunder be explained with reference to FIG. 8.

The communication unit 411 receives the trip information from the vehicles 12 via the network 14 (Step S801).

The trip information acquisition unit 412 acquires the trip information received from the communication unit 411, and stores the acquired trip information in the trip information storage unit 413 (Step S802).

The differential calculation unit 414 calculates the time of stay of the vehicle 12 at the arrival point of the target trip based on the history of the trip information stored in the trip information storage unit 413 (Step S803).

The trip purpose estimation unit 415 estimates the trip purpose of the passenger of the vehicle 12 to the arrival point of the target trip based on the time of stay calculated by the differential calculation unit 414 (Step S804).

The advertising information generator 416 generates the advertising information offered to the passenger of the vehicle 12 based on the trip purpose estimated by the trip purpose estimation unit 415 (Step S805).

Then, the advertising information generator 416 controls the communication unit 411 to transmit the generated advertising information to the vehicle 12 and the mobile device 13 (Step S806).

As such, according to the trip purpose estimation system of the embodiment, the trip purpose may be estimated based on the information which relates to the action of the passenger of the vehicle 12 at the arrival point of the target trip so that the estimation accuracy of the trip purpose at the arrival point of the passenger of the vehicle 12 may be enhanced.

According to the embodiment, the trip purpose estimation apparatus (11) includes the trip information acquisition unit (412) acquiring trip information per trip of the vehicle (12), the trip information including the departure point, the arrival point, the departure time, and the arrival time of the vehicle (12), the trip information storage unit (413) storing the history of the trip information acquired by the trip information acquisition unit (412), the differential calculation unit (414) calculating the time of stay of the vehicle (12) at the arrival point of the target trip based on the history of the trip information stored in the trip information storage unit (413), the target trip corresponding to the trip in which the trip purpose of the passenger of the vehicle (12) is estimated, and the trip purpose estimation unit (415) estimating the trip purpose of the passenger of the vehicle (12) to the arrival point of the target trip based on the calculated time of stay.

According to the above-described configuration, as an example of the effects, the estimation accuracy of the trip purpose at the arrival point of the passenger of the vehicle may be enhanced.

According to the embodiment, in a case where the target trip corresponds to the latest trip, the differential calculation unit (414) estimates the trip information of the following trip of the target trip based on the history of the trip information stored in the trip information storage unit (413), and calculates the time of stay based on the trip information of the target trip and the estimated trip information.

According to the above-described configuration, as an example of the effects, even in a case where the target trip is the latest trip, the time of stay at the arrival point of the target trip may be calculated.

According to the embodiment, the trip purpose estimation unit (415) estimates the trip purpose of the target trip based on the calculated time of stay and the estimation result of the trip purpose of the last trip of the target trip.

According to the above-described configuration, as an example of the effects, the estimation accuracy of the trip purpose at the arrival point of the passenger of the vehicle may be further enhanced.

According to the embodiment, the trip information includes at least one of the number, the sex, and the age of the passenger of the vehicle (12), the differential calculation unit (414) estimates the composition of the passengers of the vehicle (12) based on the history of the trip information stored in the trip information storage unit (413), and the trip purpose estimation unit (415) estimates the trip purpose of the target trip based on the time of stay and the composition of the passengers.

According to the above-described configuration, as an example of the effects, the estimation accuracy of the trip purpose at the arrival point of the passenger of the vehicle may be further enhanced.

According to the embodiment, the differential calculation unit (414) calculates the change of the number of the passengers of the vehicle (12) at the arrival point of the target trip based on the history of the trip information stored in the trip information storage unit (413), and the trip purpose estimation unit (415) estimates the trip purpose of the target trip based on the time of stay, the change of the number of the passengers, and the composition of the passengers.

According to the above-described configuration, as an example of the effects, the estimation accuracy of the trip purpose at the arrival point of the passenger of the vehicle may be further enhanced.

According to the embodiment, the trip information includes at least one of the number and the weight of the loads loaded on the vehicle (12), the differential calculation unit (414) calculates increase and decrease of the loads at the arrival point of the target trip based on the history of the trip information stored in the trip information storage unit (413), and the trip purpose estimation unit (415) estimates the trip purpose of the target trip based on the time of stay and the increase and decrease of the loads.

According to the above-described configuration, as an example of the effects, the estimation accuracy of the trip purpose at the arrival point of the passenger of the vehicle may be further enhanced.

According to the embodiment, the trip information includes driving information showing the driving tendency of a driver of the vehicle (12), and the trip purpose estimation unit (415) estimates the trip purpose of the target trip based on the time of stay and the driving information included by the trip information of the target trip.

According to the above-described configuration, as an example of the effects, the estimation accuracy of the trip purpose at the arrival point of the passenger of the vehicle may be further enhanced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A trip purpose estimation apparatus, comprising:
a trip information acquisition unit acquiring trip information per trip of a vehicle, the trip information including a departure point, an arrival point, a departure time, and an arrival time of the vehicle;
a trip information storage unit storing a history of the trip information acquired by the trip information acquisition unit;
a differential calculation unit calculating a time of stay of the vehicle at the arrival point of a target trip based on the history of the trip information stored in the trip information storage unit, the target trip corresponding to the trip in which a trip purpose of a passenger of the vehicle is estimated; and
a trip purpose estimation unit estimating the trip purpose of the passenger of the vehicle to the arrival point of the target trip based on the calculated time of stay.

2. The trip purpose estimation apparatus according to claim 1, wherein
in a case where the target trip corresponds to a latest trip,
the differential calculation unit estimates the trip information of a following trip of the target trip based on the history of the trip information stored in the trip information storage unit, and
calculates the time of stay based on the trip information of the target trip and the estimated trip information.

3. The trip purpose estimation apparatus according to claim 1, wherein the trip purpose estimation unit estimates the trip purpose of the target trip based on the calculated time of stay and the estimation result of the trip purpose of a last trip of the target trip.

4. The trip purpose estimation apparatus according to claim 1, wherein
the trip information includes at least one of a number, a sex, and an age of the passenger of the vehicle,
the differential calculation unit estimates a composition of the passengers of the vehicle based on the history of the trip information stored in the trip information storage unit, and
the trip purpose estimation unit estimates the trip purpose of the target trip based on the time of stay and the composition of the passengers.

5. The trip purpose estimation apparatus according to claim 4, wherein
the differential calculation unit calculates a change of the number of the passengers of the vehicle at the arrival point of the target trip based on the history of the trip information stored in the trip information storage unit, and
the trip purpose estimation unit estimates the trip purpose of the target trip based on the time of stay, the change of the number of the passengers, and the composition of the passengers.

6. The trip purpose estimation apparatus according to claim 1, wherein
the trip information includes at least one of a number and a weight of loads loaded on the vehicle,
the differential calculation unit calculates increase and decrease of the loads at the arrival point of the target trip based on the history of the trip information stored in the trip information storage unit, and
the trip purpose estimation unit estimates the trip purpose of the target trip based on the time of stay and the increase and decrease of the loads.

7. The trip purpose estimation apparatus according to claim 1, wherein
the trip information includes driving information showing a driving tendency of a driver of the vehicle, and
the trip purpose estimation unit estimates the trip purpose of the target trip based on the time of stay and the driving information included by the trip information of the target trip.
